(19) United States
(12) Patent Application Publication
(10) Pub. No.: US 2012/0041963 A1
(43) Pub. Date: Feb. 16, 2012

(54) PROVIDING SELECTED ATTRIBUTES OF STREAMING DATA FOR DISPLAY BY A VISUALIZATION ENGINE

(76) Inventors: Guruprasad Chintakunta, London (GB); Rajesh Kottakota, Bangalore (IN); Ming C. Hao, Palo Alto, CA (US); Song Wang, Austin, TX (US); Chetan Kumar Gupta, Austin, TX (US); Abhay Mehta, Austin, TX (US); Umeshwar Dayal, Saratoga, CA (US)

(21) Appl. No.: 12/854,967

(22) Filed: Aug. 12, 2010

(51) Int. Cl. G06F 17/30

(52) U.S. Cl. 707/756; 707/769; 707/E17.014

(57) ABSTRACT

An adapter receives tuples of streaming data from a streaming data source. The adapter extracts selected attributes from the tuples of streaming data, and writes the selected attributes to a buffer associated with a visualization engine for displaying the selected attributes in a visualization screen. The selected attributes are written to the buffer according to a predefined format supported by the visualization engine. The adapter receives interactive user input to change the selected attributes to be extracted from the tuples and written to the buffer.

### BACKGROUND

Queries can be submitted to data management engines to cause output of data in response to the queries. Certain types of data management engines are streaming data engines in which outputs are in the form of streams of data.

### BRIEF DESCRIPTION OF THE DRAWINGS

Some embodiments are described with respect to the following figures:

FIG. 1 is a flow diagram of a process of processing streaming data to allow for visualization of selected attributes in the streaming data, according to some embodiments; and

FIG. 2 is a block diagram of an example arrangement that incorporates some embodiments; and

FIG. 3 is a block diagram of example components for enabling visualization of streaming data, in accordance with some embodiments.

### DETAILED DESCRIPTION

To allow for efficient understanding of relative large amounts of data, visualization engines are provided to generate graphical visualizations of the data. Examples of graphical visualizations include cell-based visualizations (in which data records are represented by corresponding cells that may be assigned visual indicators, such as color, corresponding to attributes of interest), scatter plots, pixel bar charts (which has multiple bars, each including respective arrangements of pixels corresponding to respective data records), and so forth. Many visualization engines expect the input data to have a certain format. Often, the format of input data expected by visualization engines is in a form having columns corresponding to attributes to be visualized.

Existing visualization engines are usually not able to efficiently visualize streaming data provided by a streaming data source. “Streaming data” refers to a continual transmission of data as data becomes available. Streaming data is typically provided in the form of tuples, where a “tuple” refers to a data structure having multiple attributes. Tuples of streaming data may not be effectively used by existing visualization engines, since the tuples of streaming data are not in the proper format for these visualization engines.

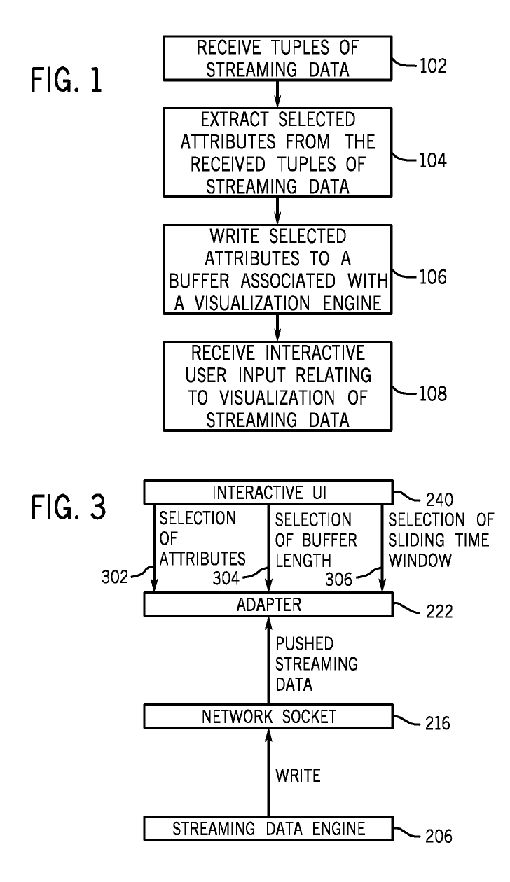

In accordance with some embodiments, an adapter is provided to receive tuples of streaming data and to extract selected attributes of interest, where the selected attributes are provided to a buffer that arranges the selected attributes in the correct format that is supported by a visualization engine. FIG. 1 is a flow diagram of a process performed by an adapter according to some embodiments. The adapter receives (at 102) tuples of streaming data from a streaming data source. The streaming data source can be a data management engine that is able to receive queries and to respond to such queries with output data in the form of data streams. In other implementations, other types of streaming data sources can be provided.

The adapter extracts (at 104) selected attributes from the received tuples of streaming data, and writes (at 106) the selected attributes to a buffer associated with a visualization engine for displaying the selected attributes in a visualization screen generated by the visualization engine. The selected attributes written to the buffer are according to a predefined format supported by the visualization engine.

The adapter can receive (at 108) interactive user input relating to the visualization of the streaming data. In some implementations, the received interactive user input relates to the selection of attributes to be extracted from the tuples of streaming data for writing to the buffer, such that the selected attributes can be visualized. For example, as a user's interests change over time, the user can change the attributes to be visualized. The user can thus submit user input indicating which attributes to delete and/or to add for visualization by the visualization engine.

Another interactive user input that can be received by the adapter includes user input relating to a time window of interest, where the visualization engine is to display streaming data in the selected time window. The ability to select a time window gives the user the ability to visualize just streaming data in the selected time window, such that the user is not overwhelmed with vast amounts of displayed data. The time window can be a sliding time window that shifts over time. The end of each time window is also useful to indicate that a result of an aggregate function (e.g., a function to calculate an average, mean, maximum, minimum, sum, or other aggregate) is available for display. The aggregate function is computed based on the streaming data values in the sliding time window—the end of the time window can be used to signal that the result of the aggregate function is available for a time window that has just passed.

Another interactive user input that can be received by the adapter specifies a total length of the buffer in which selected streaming data is to be stored. Specifying the total length of the buffer allows the user to control the amount of data that is to be stored in the buffer, such that the stored streaming data does not overwhelm memory in the receiving system.

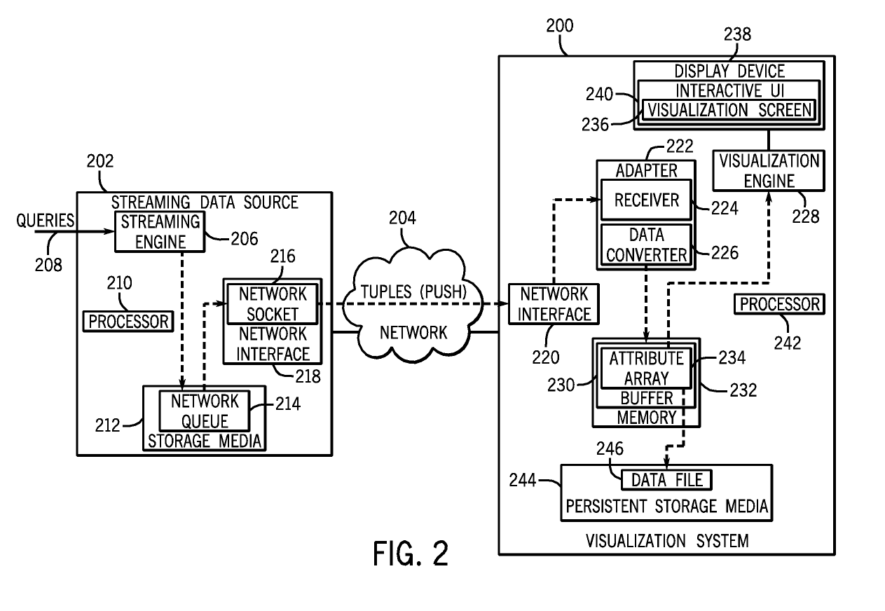

FIG. 2 depicts an example system according to some embodiments. FIG. 2 depicts a visualization system 200 and a streaming data source 202, which are depicted as separate systems connected over a data network 204. In alternative implementations, instead of providing the visualization system 200 and the streaming data source 202 as separate systems, these two systems can be integrated into one system.

The streaming data source 202 has a streaming engine 206 that is able to receive queries (208). In response to a query, the streaming engine 206 retrieves data that satisfies the query for output as streaming data from the streaming data source 202. The streaming data source 202 can receive data from various data sources (not shown).

The streaming engine 206 is executable on one or multiple processors 210. The processor(s) 210 is (are) connected to a storage media 212 (persistent or non-persistent storage media) in the streaming data source (202). In the example arrangement of FIG. 2, the storage media 212 includes a network queue 214, where the network queue 214 is associated with the streaming engine 206. Data retrieved in response to a query is provided to the network queue 214 by the streaming engine 206.

The content of the network queue 214 is provided to a network socket 216 of a network interface 218 in the streaming data source 202. In some examples, the network socket 218 can be a TCP/IP (Transmission Control Protocol/Internet Protocol) socket. In other implementations, the network socket 216 can be according to other communications protocols.

Writing of data to the network socket 216 causes the data (tuples of streaming data) to be pushed over the network 204 to the visualization system 200. The push model for communicating the tuples of streaming data is in contrast to a pull model, where the visualization system 200 has to actively retrieve data from the streaming data source 202. Pushing of tuples from the streaming data source 202 to the visualization system 200 allows the data to be continually sent to the visualization system 200 as the data becomes available, which can reduce delays in communicating the tuples of streaming data to the visualization system 200. Also, the push model is able to avoid sending of requests as used in the pull model, where the requests add to overall traffic in the network 204 which can consume valuable network bandwidth.

The visualization system 200 includes a network interface 220 that receives data (including pushed tuples of streaming data) over the network 204. The tuples of streaming data from the streaming data source 202 are provided through the network interface 220 to an adapter 222 according to some implementations, where the adapter 222 has a receiver 224 and a data converter 226. The receiver 224 receives the tuples of streaming data that have been received over the network 204.

The data converter 226 converts the received tuples of data into the appropriate format for use by a visualization engine 226 in the visualization system 200. In some implementations, the data converter 226 extracts selected attributes from the tuples of streaming data received by the receiver 224. “Selected attributes” refers to attributes that have been selected by the visualization system 200, such as in response to user input and/or based on other criteria.

The extracted, selected attributes are provided to a buffer 230 that is in a memory 232 of the visualization system 200. As used here, “memory” refers to non-persistent or other type of relatively high-speed storage media, as compared to persistent storage media 244. In some implementations, the buffer 230 is used to store an attribute array 234, where the attribute array 234 has multiple columns for storing respective selected attributes as selected by the adapter 222.

The selected attributes in the attribute array 234 are read by the visualization engine 228 for display in a visualization screen 236 that is displayed in a display device 238. The visualization screen 236 is part of an interactive user interface 240, where the interactive user interface has control elements selectable by a user to perform various control tasks with respect to visualization of the streaming data received by the visualization system 200.

The visualization engine 228 and adapter 222 are executable on one or multiple processors 242, which is (are) connected to the network interface 220, the memory 232, and the storage media 244. In some implementations, the content of the buffer 230 can be written to a data file 246 in the persistent storage media 244. The data file 246 stored in the persistent storage media 246 can be accessed at a later time, if desired.

FIG. 3 shows example components involved in enabling visualization of selected attributes from tuples of streaming data. As shown in FIG. 3, the streaming engine 206 writes streaming data (e.g., data retrieved in response to a query or multiple queries) to the network socket 216. The network socket 216 pushes the tuples of streaming data to the adapter 222. The adapter 222 is able to receive various control commands from the interactive user interface 240. In the example of FIG. 3, the commands that are received from the interactive user interface 240 can include a selection of attributes (302), a selection of buffer length (304), and/or a selection of a sliding time window (306). Over time, the attributes of interest to a user may change, in which case the user can select, through the interactive user interface 240, changed attributes to be visualized (by submitting a different selection 302 of attributes), where the different selection can involve addition and/or deletion of attributes to visualize.

The selection of buffer length (304) allows a user to control the amount of storage in the memory 232 (FIG. 2) to be allocated to storage of attributes for visualization by the visualization engine 228. As the buffer 230 becomes full, old data can be removed and new data is added. Being able to control the buffer length avoids the situation where the memory 232 of the visualization system 200 becomes overwhelmed with received streaming data.

The selection of a sliding time window (306) that can be made by a user allows the user to specify a particular time window that is of interest to the user. This avoids the situation where too much data over a relatively long period of time is displayed in the visualization screen 236, which can result in excessive data being visualized that can obscure the data of interest.

The tuples of streaming data provided by the streaming data source 202 to the visualization system 200 (FIG. 2) is according to a data schema that is agreed to between the streaming data source 202 and the adapter 222. Note that the data schema specifies a format of the streaming data that is not supported by the visualization engine 228. The data schema defines the specific format of the tuples that are to be exchanged between the streaming data source 202 and the adapter 222. The receipt of tuples from the streaming data source 202 by the adapter 222 is according to this data schema, which allows the adapter 222 to parse the data such that selected attributes can be extracted.

A loose coupling is provided by some implementations between the streaming data source 202 and the visualization engine 228. Such loose coupling is provided by the adapter 222. In this manner, even if the visualization engine 228 were to be modified, simple changes can be made to the adapter 222 to allow for continued visualization of streaming data from the streaming data source 202.

The streaming engine 206, adapter 222, and visualization engine 228 can be implemented as machine-readable instructions that are loaded for execution on a processor (e.g., processor(s) 210 and/or processor(s) 242 in FIG. 2). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by an adapter in a system having a processor, tuples of streaming data from a streaming data source;
extracting, by the adapter, selected attributes from the tuples of streaming data;
writing, by the adapter, the selected attributes to a buffer associated with a visualization engine for displaying the selected attributes in a visualization screen, wherein the selected attributes are written to the buffer according to a predefined format supported by the visualization engine; and
receiving, by the adapter, interactive user input to change the selected attributes to be extracted from the tuples and written to the buffer.

2. The method of claim 1, wherein receiving the tuples of streaming data comprises receiving the tuples of streaming data pushed from the streaming data source to the adapter, wherein pushing of the tuples of streaming data allows the adapter to continually receive the tuples of streaming data without the adapter having to actively request the tuples of streaming data.

3. The method of claim 1, further comprising receiving further user input to select a time window of interest, wherein selection of the time window causes display in the visualization screen of streaming data within the selected time window and excludes from display in the visualization screen streaming data outside the selected time window.

4. The method of claim 3, wherein selecting the time window comprises selecting a sliding time window that moves over time.

5. The method of claim 1, further comprising;
receiving further user input specifying a length of the buffer.

6. The method of claim 1, further comprising:
using a particular data schema by the adapter, wherein the particular data schema is also used by the streaming data source for the tuples of streaming data.

7. The method of claim 1, wherein writing the selected attributes to the buffer comprises writing the selected attributes to an array having columns corresponding to the selected attributes.

8. The method of claim 7, further comprising:
reducing a size of the array by removing a column for a corresponding attribute that has been deselected by the interactive user input.

9. The method of claim 7, further comprising:
adding a column to the array for a corresponding attribute that has been added in response to the interactive user input.

10. An article comprising at least one machine-readable storage medium storing instructions that upon execution cause a system having a processor to:
receive, by an adapter, streaming data from a streaming data source according to a data schema, wherein the data schema specifies a format that is not supported by a visualization engine;
convert, by the adapter, the received streaming data into a predefined format that is supported by the visualization engine, wherein the converting includes selecting attributes of the received streaming data to extract;
write, by the adapter, the selected attributes of the streaming data to an array in memory that is accessible by the visualization engine for visualization; and
receive, by the adapter, interactive user input to relating to visualization of the streaming data by the visualization engine.

11. The article of claim 10, wherein receiving the interactive user input comprises receiving input selecting the attributes of the received streaming data to visualize by the visualization engine.

12. The article of claim 10, wherein receiving the interactive user input comprises receiving input specifying a length of a buffer in the memory to store the array.

13. The article of claim 10, wherein receiving the user input comprises receiving input specifying a time window of the streaming data to visualize.

14. The article of claim 10, wherein writing the selected attributes of the streaming data to the array in the memory comprises writing the selected attributes of the streaming data into respective columns of the array.

15. The article of claim 10, wherein receiving the streaming data comprises receiving streaming data pushed by the streaming data source.

16. The article of claim 10, wherein receiving the streaming data comprises receiving tuples of the streaming data according to the data schema.

17. The article of claim 10, wherein the adapter is separate from the visualization engine.

18. A system comprising:
at least one processor;
an adapter executable on the at least one processor to:
receive tuples of streaming data from a streaming data source;
extract selected attributes from the tuples of streaming data;
write the selected attributes to a buffer;
receive interactive user input to change the selected attributes to be extracted from the tuples and written to the buffer; and
a visualization engine executable on the at least one processor to:
read the selected attributes from the buffer;
cause display of the selected attributes in a visualization screen generated by the visualization engine, wherein the selected attributes are written by the adapter to the buffer according to a predefined format supported by the visualization engine.

19. The system of claim 18, wherein the received tuples are according to a data schema specifying a format not supported by the visualization engine, and wherein the adapter is executable to further convert the tuples into the predefined format supported by the visualization engine.
